(19) United States
(12) Patent Application Publication
(10) Pub. No.: US 2003/0028719 A1
(43) Pub. Date: Feb. 6, 2003

(54) Disc drives divided into multiple logical containers

(76) Inventor: Satish L. Rege, Minneapolis, MN (US)

Correspondence Address: Joseph R. Kelly, WESTMAN CHAMPLIN & KELLY, International Centre - Suite 1600, 900 South Second Avenue, Minneapolis, MN, 55402-3319, US

(21) Appl. No.: 10/116,820

(22) Filed: Apr. 5, 2002

Related U.S. Application Data
(60) Provisional application No. 60/310,371, filed on Aug. 6, 2001.
(60) Provisional application No. 60/348,428, filed on Oct. 29, 2001.

(51) Int. Cl. G06F 12/00

(52) U.S. Cl. 711/112; 711/154; 711/114

(57) ABSTRACT

Either the disc drive controller or an external software component can divide the storage space on the disc drive into a plurality of different logical components. The disc drive controller also stores parameters that indicate a property data stored in each one of the logical containers. This allows the external software component to access this drive management data, and it allows the block oriented disc drives, themselves, to greatly enhance the efficiency with which data is accessed on the disc drive. The present invention can also be implemented as a method of accessing information on a block oriented disc drive.

### CROSS-REFERENCE TO RELATED APPLICATION

This application claims priority from U.S. Provisional Application Nos. 60/310,371, filed on Aug. 6, 2001 and 60/348,428 filed on Oct. 29, 2001 for inventor Satish L. Rege and entitled INTELLIGENT DISKS WITH MULTIPLE LUN'S.

### FIELD OF THE INVENTION

The present invention deals with disc drives. More specifically, the present invention deals with disc drives divided into multiple logical containers for improving storage capability and service.

### BACKGROUND OF THE INVENTION

Disc drives conventionally include a disc drive controller (or CPU), reading electronics, writing electronics and one or more storage discs. The storage discs are conventionally mounted for co-rotation about a central axis. Data is typically stored in concentric tracks on the disc surfaces, and data on the disc surfaces is accessed (read from and written to the disc surfaces) by one or more transducers.

In order to read information from a disc surface, a servo system is configured to position the data transducer relative to a desired location (e.g., a desired track or cylinder) on the disc surface such that the transducer can generate a read signal indicative of data encoded on the disc surface. The read signal is provided through the read electronics and the CPU back to a host system which requested the data.

During the read operation, the servo system controls the data transducer in a track following mode in which the data transducer follows the track over the disc surface topography so that data can be read from the desired track.

During a write operation, the servo system positions the head relative to a track to be written. The host system provides data to the CPU and the CPU, in turn, provides the data through the write electronics such that it can be encoded on the disc surface at the desired location.

It can thus be seen that the actual reading and writing of data to the disc surfaces is controlled by the CPU on the disc drive. However, in conventional disc drives, higher level data storage management and planning services are provided by an external controller (such as the host system), external to the disc drive.

From the view point of the CPU on the disc drive, all data is treated equally, in that it is accessed (written to and read from the disc surfaces) in the same manner, regardless of what type of data it is or of what properties the data has. This is true primarily because each disc drive is treated as a single logical unit number (LUN), or logical container. Disc drives are treated in this fashion even in array applications where multiple disc drives are controlled in coordination with one another by an external array controller.

In addition, some disc drive software applications in the host computer (such as software applications that manage the logical storage volume of the disc drive) are currently unable to retrieve parameters associated with operating information for individual disc drives. In the past, a solution to this problem would require many different modifications to the software application. For example, host computers are currently manufactured by a wide variety of different manufacturers. Within each of those host computers, the host disc drive controller is also manufactured by a number of different manufacturers. Therefore, the software application would require modification for each different combination of host computer and host controller. Similarly, array controllers, which may be external to the host computer, are also manufactured by a variety of different manufacturers. This vastly increases the combinatorial requirements for software modification.

The present invention addresses one or more of these disadvantages and offers one or more advantageous features over the prior art.

### SUMMARY OF THE INVENTION

Either the disc drive controller or an external software component can divide the storage space on the disc drive into a plurality of different logical components. The disc drive controller also stores parameters that indicate a property of data stored in each one of the logical containers. This allows the external software component to access this drive management data, and it allows the block oriented disc drives, themselves, to greatly enhance the efficiency with which data is accessed on the disc drive. The present invention can also be implemented as a method of accessing information on a block oriented disc drive.

### BRIEF DESCRIPTION OF THE DRAWINGS

FIG. 1 is an illustrative elevational view of a disc drive in accordance with one embodiment of the present invention.

FIG. 2 is a block diagram of one embodiment of the present invention.

FIG. 3 is a flow diagram illustrating one embodiment of operation of the present invention.

FIG. 4 is an illustration of a disc surface divided in accordance with one embodiment of the present invention.

FIG. 5 is a block diagram of another embodiment of the present invention.

### DETAILED DESCRIPTION OF ILLUSTRATIVE EMBODIMENTS

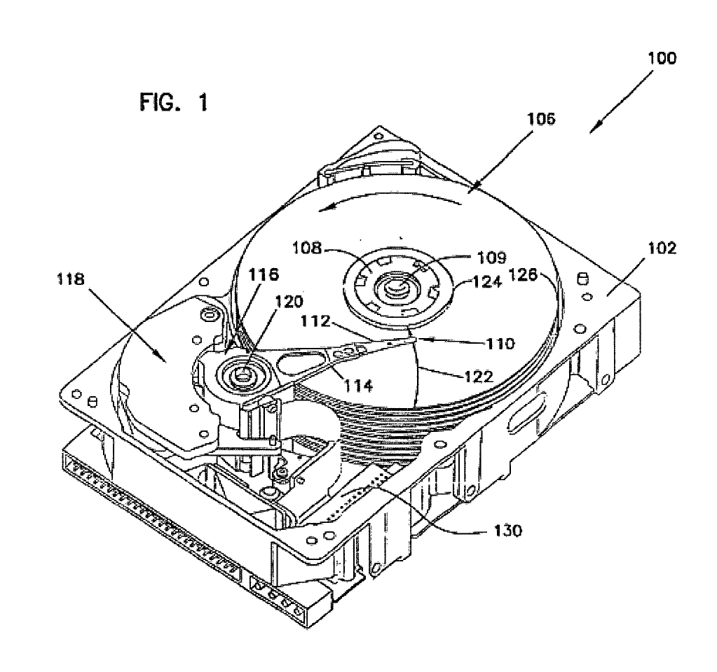

FIG. 1 illustrates an embodiment of a disc drive storage device 100. Disc drive 100 is a block oriented device that includes a housing 102 that houses a disc pack 126 of discs 106 secured by clamps 124 to a spindle motor 108. Each disc 106 has at least one storage surface 105 that is illustratively a layer of material (such as magnetic material or optically readable material) suitable for storing data. Each disc 106 is accessible by a read/write assembly 112 which includes a transducer or head 110. Spindle motor 108 drives rotation of the discs 106 in disc pack 126 in a direction of rotation about spindle 109.

As discs 126 are rotated, read/write assembly 112 accesses different rotational locations on the storage surfaces 105 in disc pack 126. Read/write assembly 112 is actuated for radial movement relative to the disc surfaces, such as in a direction indicated by arrow 122, in order to access different tracks (or radial positions) on the disc surfaces. Such actuation of read/write assembly 112 is illustratively provided by a servo system which can include a voice coil motor (VCM) 118. Voice coil motor 118 includes a rotor 116 that pivots on axis 120. VCM 118 also illustratively includes an arm 114 that supports the read/write head assembly 112.

Disc drive 100 illustratively includes control circuitry 130 (which includes a CPU) for controlling operation of disc drive 100 and for transferring data in and out of the disc drive 100. CPU 130 illustratively controls the actual reading and writing operations on the drive 100.

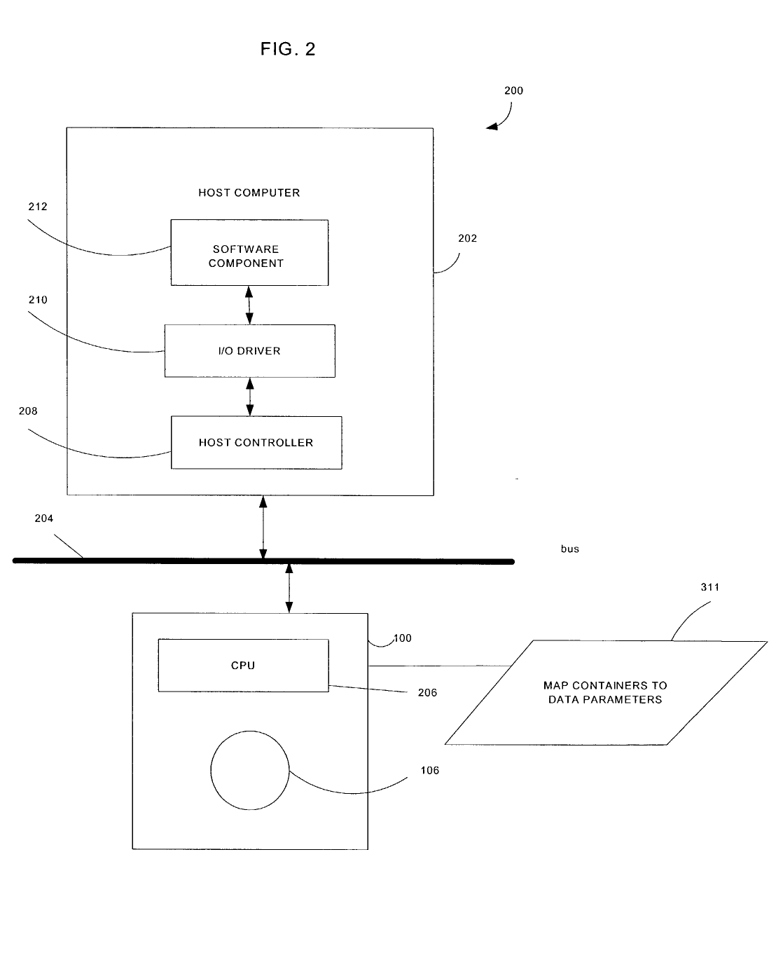

FIG. 2 is a block diagram showing relevant portions of disc drive 100 as used in a system 200 which includes host computer 202 connected to disc drive 100 by bus 204. Bus 204 can be any suitable bus, such a SCSI bus or any other bus suitable for connecting host computer 202 to disc drive 100. FIG. 2 illustrates CPU 206 which can form part of the disc drive electronics 130 of drive 100. FIG. 2 also shows a disc 106 of disc drive 100.

FIG. 2 further illustrates that host computer 202 illustratively includes host controller 208 which is a bus controller for controlling access to bus 204, and providing data to be written to CPU 206 in disc drive 100. Host controller 208 also receives data which is read from disc 106 and provided by CPU 206 in disc drive 100.

Host controller 208 is illustratively coupled to I/O driver 210 which is, in turn, coupled to a software component 212. It should be noted that software component 212 is illustratively not a user application, but is rather a disc drive application internal to host computer 202. Examples of such an application include portions of the operating system of host computer 202, or application programs that manage the logical volume of the disc drives 100 connected to host computer 202 through bus 204.

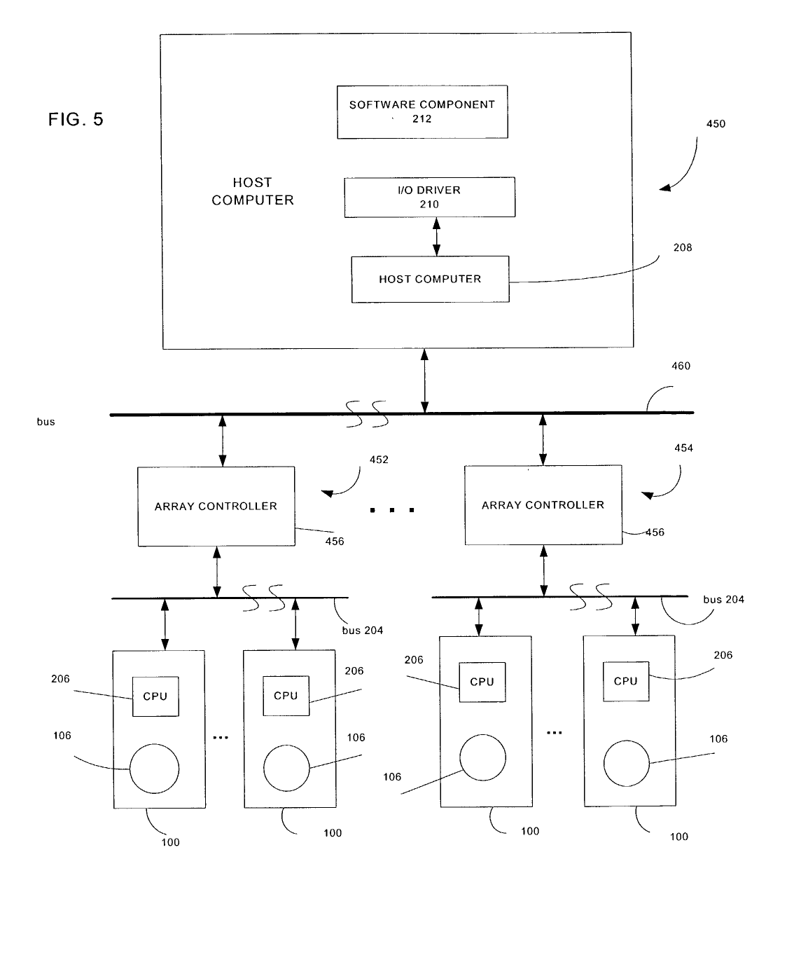

In any case, in operation, software component 212 can provide information to disc drive 100 to set up logical containers as software component 212 desires, basically without input from drive CPU 206. Similarly, in another embodiment, drive CPU 206 can create and maintain data in the logical containers. Both embodiments will be described. Also, as described in greater detail below with respect to FIG. 5, the present invention can be implemented in a disc drive array controller as well.

In general, software component 212 can provide information to disc drive 100 by accessing I/O driver 210. I/O driver 210 passes desired information back and forth between software component 212 and host controller 208. Host controller 208, in turn, controls the arbitration of bus 204, and passes information back and forth between various disc drives 100, on bus 204, and software component 212.

In the past, each disc drive 100 has been represented to software component 212 as a single logical container. Thus, CPU 206 has had no knowledge of any different types of data which are stored on disc 106. Thus, CPU 206 controlled the specific writing and reading operations on disc drive 100 the same, regardless of the specific type of data being stored on disc 106. This led to a number of problems and inefficiencies discussed in the background portion of the specification.

In accordance with one embodiment of the present invention, drive CPU 206 divides the storage space on discs 106 into a plurality of different logical containers and maintains a record of the types or properties of data stored in each logical container. In another embodiment, this is done by software component 212. CPU 206 or software component 212 can thus manage the disc accessing operations (reading and writing operations) in a much more efficient manner.

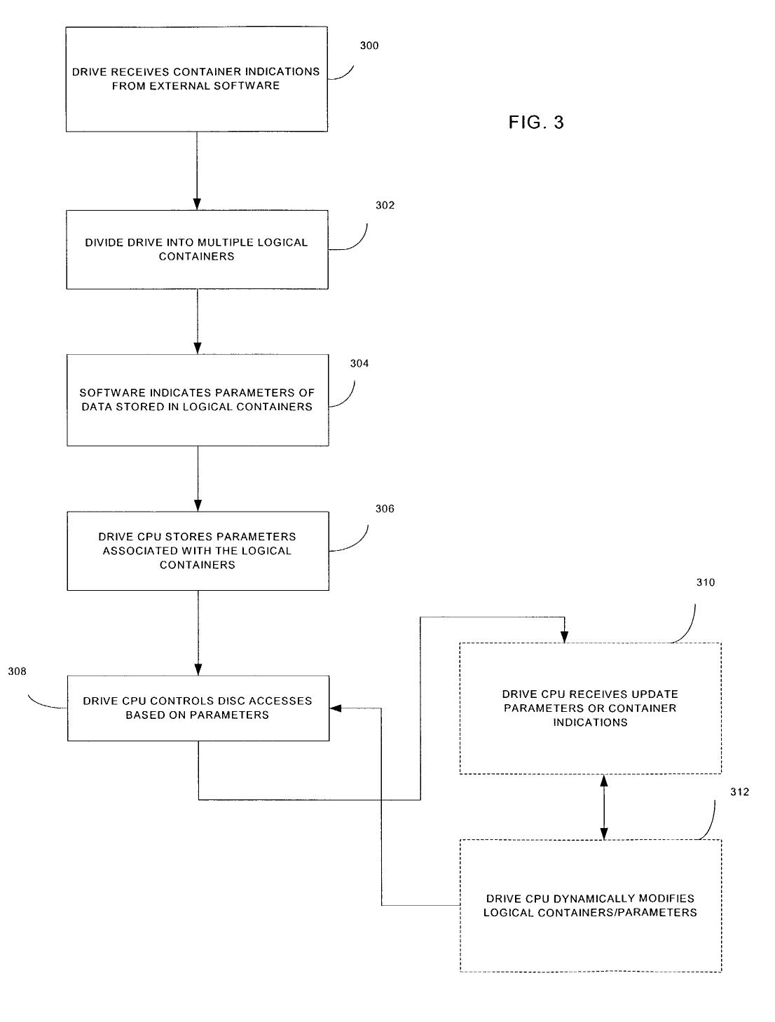

FIG. 3 is flow diagram better illustrating the operation of system 200 in accordance with one embodiment of the present invention. Disc drive CPU 206 illustratively receives container indications from software 212 indicative of a desired number of logical containers (and possibly desired container size) that the space on disc 106 is to be divided into. This is indicated by block 300 in FIG. 3. Block 300 further shows that the container indications are provided from an external software component, such as software component 212. However, it should be noted that in accordance with one embodiment of the present invention, disc drive CPU 206 can automatically divide the storage space on disc 106 into a predetermined number of logical containers as well, and they can then be modified based on inputs from software 212.

In any case, once the container indications are received by disc drive CPU 206, the drive space is divided (by software 212 or CPU 206) into multiple logical units (or containers), based on the container indications. This is indicated by block 302 in FIG. 3.

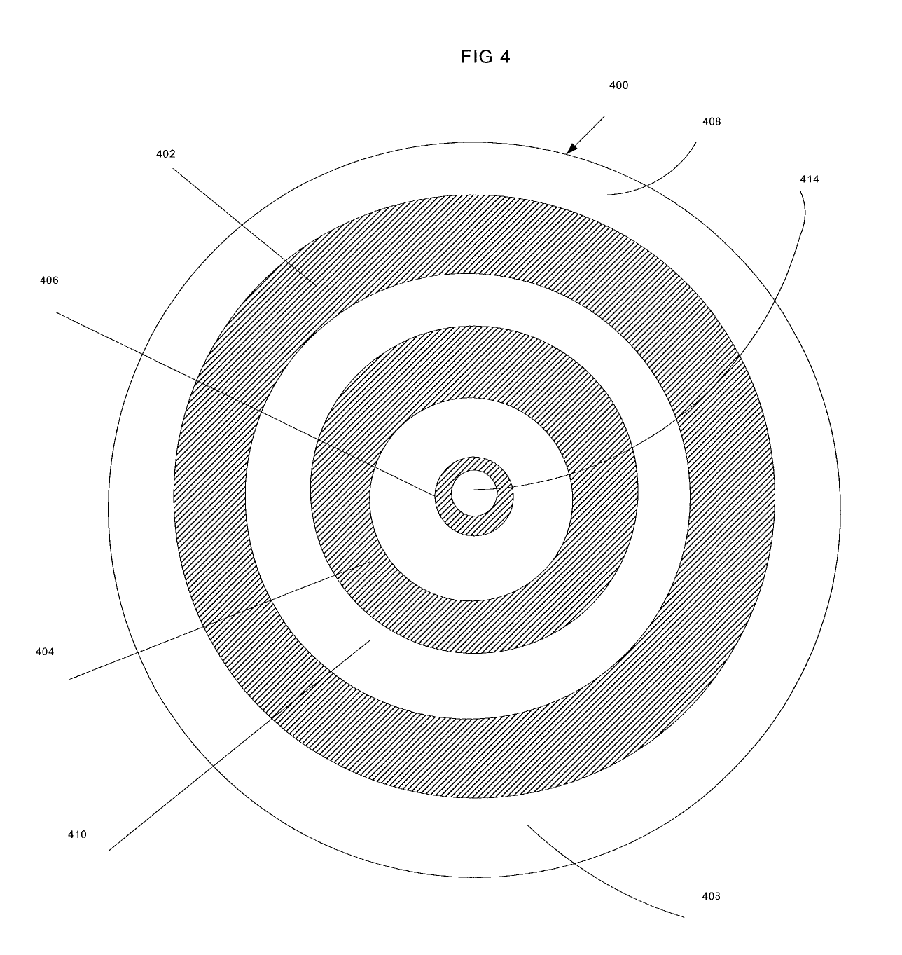

FIG. 4 is one illustrative embodiment of a disc surface 400 divided in accordance with one embodiment of the present invention. Disc surface 400 is illustratively divided into three different logical containers 402, 404 and 406 based on the inputs from software 212. While logical containers 402-406 are shown as contiguous portions of disc surface 400, that need not be the case. Any portions of disc surface 400 can be associated to form a logical container. However, in one embodiment, the logical containers are contiguous as shown.

In the embodiment shown in FIG. 4, a number of expansion zones 408, 410, 412 and 414 are provided as well. In this way, if CPU 206 receives updated container indications or parameters which indicate that any of the logical containers 402-406 should be enlarged, the expansion zones 408, 410, 412 and 414 can be re-allocated to one of the logical containers to increase the storage space of that logical container. Again, of course, though the expansion zones are each shown as contiguous portions of the disc surface, that need not be the case.

Once the drive is divided into logical containers, drive CPU 206 then receives parameters indicative of the properties of data to be stored in the logical containers (such as whether the data is sequentially accessed when written, type of error detection code used, the type of data—such as video data, and audio data, text file data, etc.). This is indicated by block 304. Again, illustratively, CPU 206 receives those indications from software component 212 which provides the indications through I/O driver 210 and host controller 208, over bus 204, to CPU 206.

CPU 206 then stores the parameters associated with the logical containers. This is indicated by block 306 in FIG. 3. FIG. 2 illustrates one data structure 311 that stores the parameters and an identification of the associated logical containers. In the embodiment shown in FIG. 2, CPU 206 stores a mapping data structure that maps the parameters indicative of the specific type of information being stored to the logical containers. Therefore, when accessing data in one of the logical containers, CPU 206 illustratively accesses map 311 to determine the specific type of data stored in that logical container. It will also be noted, of course, that software 212 can under certain circumstances, access this very detailed drive information by querying CUP 206. For example, if software 212 provides authenticating information, such as a code or a certain query input, CPU 206 will return the drive level data it has stored, to software 212.

Disc drive CPU 206 then controls disc accesses to a given logical container, based upon its associated parameters. This is indicated by block 308. In one illustrative embodiment, drive CPU 206 controls the disc accesses based on what other type of accesses are being preformed (or are in line to be preformed) at other logical containers as well. For instance, CPU 206 illustratively controls the prioritization of disc access requests, and exactly how the access requests are preformed, based upon the parameters associated with the logical containers from which data is sought, and based on what other disc access operations are currently being requested. A number of examples are discussed after the description of FIG. 5 below.

Similarly, CPU 206 can implement access control or service level processing. For instance, if host 202 requests data from drive 100 under certain performance criteria (such as timing criteria), CPU 206 can indicate to host 200 whether it can meet the specified performance criteria, even before attempting the disc access.

In accordance with another embodiment of the present invention, CPU 206 or software 212 may illustratively dynamically update the space allocated to the logical containers or the parameters associated with any given logical container. In that embodiment, CPU 206 intermittently receives updated parameters or updated container indications from software component 212 in host computer 202. This is indicated by block 310. Based on those updated parameters or updated container indications, CPU 206 updates its mapping 310 and dynamically modifies the logical containers or the parameters associated with those logical containers, as desired. This is indicated by block 312. By dynamically modifying, it is meant that even while read and write operations are being preformed by CPU 206, it can receive and update container indications and parameters to modify its own operations accordingly.

FIG. 5 is a block diagram of another embodiment 450 of the present invention. FIG. 5 is similar, in some respects, to FIG. 2 and similar items are similarly numbered. However, of note, FIG. 5 includes a plurality of disc drive arrays 452 and 454, each of which include a plurality of disc drives 100 and an associated array controller 456. Array controllers 456 communicate with the individual disc drives 100 over a bus (such as bus 204) according to a known communication protocol. Similarly, host controller 208, rather than communicating directly with drive CPUs 206, now communicates with drive CPUs 206 through individual array controllers 456 over bus 460, also in accordance with known communication protocols.

However, the invention can be implemented in system 450 equally as well as in system 200 shown in FIG. 2. In other words, external software component 212 provides CPUs 206 with container indications and parameters. The container indications, as in the embodiment shown in FIG. 2, indicate the number of containers (and possibly the size of each container) into which the storage space associated with that particular disc drive 100 is to be divided. The parameters indicate the type of data to be stored in each one of the logical containers in the disc drive (although default types can be used as well). The CPUs 206 then store those parameters and associate them with the desired logical containers as discussed above with respect to FIGS. 2 and 3. Operation then proceeds in the same fashion as that described with respect to FIG. 2.

It should also be noted that, in one embodiment, software component 212 can interrogate CPU 206. In doing this, software component 212 simply requests CPU 206 to provide its data structure (such as mapping structure 311) which indicates the various different logical containers, and the types of data currently stored in those logical containers, back to software component 212. This allows software component 212 to configure its data access requests efficiently. It should also be noted that logical containers can be allocated for substantially any type of data, such as the frequency the data head is writing at, whether and when the data head has crashed, different or additional operating parameters etc. Software 212 can access this information by querying the drive to provide access to the information in that particular logical container.

A number of different examples will now be discussed with respect to FIGS. 2-5. As a first example, assume that the parameters associated with logical container 402 indicate that data to be stored in that field is to be randomly accessed and has very loose real time requirements (in that it is not crucial that data be accessed quickly). Assume also that the parameters associated with logical container 404 indicate that data to be stored in that logical container are files which will typically be sequentially accessed. Assume further that the parameters associated with logical container 406 indicate that the data to be stored in that container are video clips.

By knowing these properties, CPU 206 or software 212 intelligently decides how to prioritize accesses made by clients to the various logical containers 402-406. An access to logical container 404, for example, where data is to be sequentially accessed, causes CPU 206 to prefetch and cache additional data from container 404, knowing that additional data will likely be accessed in a predetermined order. In fact, if drive 100 is lightly loaded with data, then it may be advantageous for CPU 206 to fetch data in anticipation of a sequential access to logical container 404.

Similarly, an access to logical container 402 indicates that there would be substantially no benefit for CPU 206 to prefetch and cache data, since the data is randomly accessed.

A disc access to logical container 406 is not only sequential, but has fairly tight real time requirements. Thus, CPU 206 or software 212 can prioritize data accesses to container 406 before those to container 402. CPU 206 or software 212 thus intelligently accesses, caches, and delivers data depending upon the parameters associated with the given logical containers which are being accessed.

In accordance with another example, when software component 212 requests CPU 206 to create a logical container 402, CPU 206 may illustratively create two identical logical containers 402 and 404. By identical, it is meant that the two logical containers 402 and 404 are of the same size. If disc drive 100 were provided with multiple discs or disc surfaces, then the two identical logical containers can be created within the same cylinder. When data is to be written to logical container 402, it is mirrored by CPU 206 or under control of software 212 in logical container 404, except that it is recorded 180 degrees out of phase with respect to the data recorded in logical container 402. When a seek is performed to access the data stored in logical container 402, CPU 206 simply determines which logical container (402 or 404) the data transducer is closest to, and accesses the data from that particular logical container. In addition, CPU 206 can determine whether the data transducer is closer to the beginning of the data stored in logical container 402 or to that stored in logical container 404 (since they are recorded 180 degrees out of phase). This further reduces the latency in accessing the data, because not only is the seek latency reduced, but the rotational latency is reduced as well.

Of course, it is within the scope of the invention to define additional logical containers and have the data repeated additional times. An example of this is to create four identical logical containers and record the data in each logical container 90 degrees out of phase from the next adjacent logical container. Further, the data can be repeated on a single track by writing the same data in each sector of the track. This reduces the rotational delay time such that it is never more than the rotational delay associated with a single sector. This example thus increases performance at the cost of space.

In accordance with yet another example of the present invention, one or more logical containers on a disc drive 100 are illustratively used as a cache. When a disc drive 100 is accessed in a random access pattern, then in any given period of time, a very small amount of the data is accessed as compared to the total capacity of the disc drive. For example, in an 80 Gbyte disc drive, perhaps only 5 Gbytes or less, may be accessed in any given 24 hour period. In this example, a 5 Gbyte logical container 402 is thus created and acts as a cache for the remainder of the disc drive 100. In one illustrative embodiment, the cache illustratively maintains often-used operating system components, and may store data (such as documents or projects) that a user is working on frequently. In one illustrative embodiment, the logical container 402 chosen as the cache is located at a radial center of the disc surface between the inner and outer diameters so that seek time from anywhere on the disc surface is minimized.

In accordance with another example, CPU 206 implements security procedures based upon the particular logical container being accessed. For example, in very large disc drives (such as 1 terabyte drives) data of many different kinds may be stored on an individual disc drive 100. One example may be an organization, such as a hospital, where web page information that is accessed by users that are currently accessing the hospital's web site, may be stored in one logical container 402, while digital representations of x-rays or other medical records may be stored in another logical container 404. In that case, it is desirable to have little or no security procedures executed when a person requests access to the information stored in logical container 402, but it is desirable to have robust security procedures executed when one requests data from logical container 404. In such an embodiment, the parameters stored in data structure 310 may illustratively indicate to CPU 206 that additional security procedures have to be implemented. Such procedures may be, for example, user authentication, password recognition, data encryption, etc.

The present invention can be implemented as a method or a system for storing data on a disc 106 on a block oriented disc drive 100 wherein the disc drive 100 has a drive controller 206. Drive controller 206 divides storage space on the disc drive 100 into multiple logical containers 402-406. Data is stored in the logical containers 402-406 and parameters are stored by CPU 206. The parameters are indicative of the type of data (or a characteristic of the data) stored in each logical container 402-406. The drive controller 206 controls how it accesses the data based on the type of data as indicated by the parameters (such as in step 308).

The drive controller 206 can control how it accesses data in one of the logical containers 402-406 based on how data is being accessed in other logical containers 402-406. The drive controller 206 can divide the storage space into the multiple logical containers 402-406 such that each container 402-406 is contiguous. Similarly, the drive controller 206 can define expansion space 408-414 adjacent each associated logical container 402-406.

In one embodiment, container indications are received from an external software component 212 (such as in step 300) wherein the container indications indicate a number of logical containers desired. Drive controller 206 then divides the space into the logical containers 402-406 based on the container indications received.

Controller 206 can also receive container indications dynamically or intermittently, and then modify division of the space into logical containers 402-406 based on the updated container indications received (such as in steps 310 and 312).

In another embodiment, identical data can be stored in different logical containers 402-406. It can also be stored in skewed relation to reduce seek times.

In one embodiment, drive controller 206 stores a map 311 between the logical containers 402-406 and the parameters indicative of the data types being stored in the logical containers.

In another embodiment, the data parameters which indicate the type of data stored in logical containers 402-406 are received from an external software component 212 (such as at step 304). Drive controller 206 can also intermittently receive updated data parameters from the external software component and modify how it controls access of data in logical containers 402-406 based on the updated data parameters received (such as in blocks 310 and 312).

In yet another embodiment, drive controller 206 implements different security procedures in accessing data from logical containers 402-406 that have different associated parameters.

In yet another embodiment, drive controller 206 controls accessing, caching, and providing of data to a host computer 202 differently for data in logical containers 402-406 having different associated parameters.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the data while maintaining substantially the same functionality without departing from the scope and spirit of the present invention. In addition, although the preferred embodiment described herein is directed to a disc drive system, it will be appreciated by those skilled in the art that the teachings of the present invention can be applied to arrays, without departing from the scope and spirit of the present invention.

What is claimed is:

1. A method of storing data on a disc in a block oriented disc drive having a drive controller on the disc drive, the method comprising:
(a) the drive controller dividing storage space in the disc drive into multiple logical containers;
(b) storing data in the logical containers;
(c) storing with the drive controller, parameters indicative of the properties of data stored in each logical container; and
(d) the drive controller controlling how it accesses the data based on the properties of data as indicated by the parameters.

2. The method of claim 1 and further comprising:
(e) the drive controller controlling how it accesses data in one of the logical containers based on how data is being accessed in other logical containers.

3. The method of claim 1 wherein the dividing step (a) comprises:
(a1) reserving expansion space associated with at least some of the multiple logical containers.

4. The method of claim 3 wherein the dividing step (a) comprises:
(a2) the drive controller dividing the storage space into the multiple logical containers such that each container is contiguous.

5. The method of claim 4 wherein the reserving step (a1) comprises: defining the expansion space adjacent each associated logical container.

6. The method of claim 4 wherein the dividing step (a) comprises: intermittently changing a size of one or more logical containers.

7. The method of claim 1 wherein the dividing step (a) comprises:
(a1) receiving a container indication of the number of logical containers desired by an external software component; and
(a2) dividing the space into the logical containers based on the container indication.

8. The method of claim 7 wherein the receiving step (a1) comprises:
(a2) during drive operation, intermittently receiving update container indications; and
(a3) modifying division of the space into logical containers based on the update container indications.

9. The method of claim 1 wherein the storing step (b) comprises:
(b1) storing identical data in different logical containers.

10. The method of claim 9 wherein the storing step (b1) comprises:
(b2) storing the identical data in one logical container in skewed relation to the identical data in another logical container.

11. The method of claim 1 wherein the storing step (c) comprises:
(c1) storing a mapping between the logical containers and the parameters.

12. The method of claim 1 wherein the storing step (c) comprises:
(c2) receiving the data parameters at the drive controller from an external software component.

13. The method of claim 12 wherein the receiving step (c2) comprises:
(c3) during drive operation, intermittently receiving update data parameters; and wherein the controlling step (d) comprises,
(d1) wherein the drive controller controls how it accesses the data based on the update data parameters.

14. The method of claim 1 wherein the controlling step (d) comprises:
(d1) implementing different security procedures in accessing data from logical containers with different associated parameters.

15. The method of claim 1 wherein the controlling step (d) comprises:
(d1) controlling accessing, caching and providing data to a host computer differently for data in logical containers having different associated parameters.

16. A block oriented disc drive system comprising:
a data storage disc including a drive controller; and
a host controller coupled to the drive controller, the host controller being configured to control the drive controller to divide storage space in the disc drive into multiple logical containers and store drive management data in at least one of the logical containers and to retrieve the drive management data from the at least one of the logical containers by querying the drive controller.

17. The system of claim 16 wherein the host controller is configured to control the drive controller to store parameters indicative of a property of the data stored in each logical container, the drive controller controlling how it accesses the data based on the type of data as indicated by the parameters.

18. The system of claim 17 wherein the drive controller is further configured to control how it accesses data in one of the logical containers based upon how data is being accessed in other logical containers.

19. The system of claim 18 wherein the drive controller is further configured to store a mapping between the logical containers and the parameters.

20. The system of claim 19 wherein the drive controller is configured to receive update data parameters from an external software component at the host controller and dynamically change how it accesses data based on the update data parameters.

21. The system of claim 20 wherein the drive controller is configured to receive update container indications from the external software component and dynamically change a size or number of logical containers based upon the update container indications.

22. The system of claim 17 wherein the drive controller is configured to implement service level processing.

23. A disc drive system, comprising;
a host;
a disc; and
means for accessing disc management data on the disc by the host.

24. The disc drive of claim 23 wherein the means for accessing data comprises:
means for dividing storage space on the disc into a plurality of different logical units.

25. The disc drive of claim 24 wherein the means for accessing data further comprises means for controlling accessing operations based on stored data parameters indicative of a type of data stored in logical containers being accessed.
